(19) United States
(12) Patent Application Publication
(10) Pub. No.: US 2009/0038092 A1
(43) Pub. Date: Feb. 12, 2009

(54) HAND HELD SPONGE IMPLEMENT

(76) Inventors: Brook S. Kennedy, Jackson Heights, NY (US); Kristin E. Buentello, Newtown, PA (US); Burton M. Like, East Brunswick, NJ (US); Yvonne Lin, New York, NY (US); Anton Ljunggren, New York, NY (US); Dean M. Mohamed, Clifton, NJ (US); Richard Whitehall, New York, NY (US)

Correspondence Address: CHURCH & DWIGHT CO., INC., LAW DEPT. - PATENTS, 469 NORTH HARRISON STREET, PRINCETON, NJ, 08543-5297, US

(21) Appl. No.: 11/834,117

(22) Filed: Aug. 6, 2007

(51) Int. Cl. A47L 13/17; A47L 13/022; A47L 13/10; B25G 1/10; A47L 13/16

(52) U.S. Cl. 15/104.94; 15/104.001; 15/105; 15/143.1

(57) ABSTRACT

The present invention is directed to a cleaning implement for use in household cleaning applications. In accordance with the present invention, the cleaning implement comprises a base, a handle extending from said base and a cleaning pad, which is attached to the base. The cleaning pad of the present invention contains two separate cleaning surfaces that optionally can act on two separate planes, simultaneously. In one embodiment, the cleaning pad is removable and disposable.

### FIELD OF THE INVENTION

The present invention discloses a cleaning implement for household cleaning applications. More specifically, the present invention is directed to a hand held cleaning implement with cleaning pad which has two separate cleaning surfaces.

### BACKGROUND OF THE INVENTION

Abrasive scrubbing pads are commonly used for many cleaning and personal care practices. In general, scrubbing pads include a naturally occurring or manufactured abrasive material. Examples of typical abrasive materials commonly used in the past include pumice, loofah, steel wool, and a wide variety of plastic materials. A non-absorbent abrasive material is often combined with an absorbent sponge-like backing material in these products. For example, the abrasive material often forms a layer on a multi-layer product which also includes an absorbent layer of natural sponge, regenerated cellulose, or some other type of absorbent foamed product.

These scrubbing pads tend to be expensive, making them unsuitable for a disposable or single-use product. Due to the nature of the product use, however, the products can become fouled with dirt, grease, bacteria, and other contaminants after only one or two uses. As a result, consumers must replace these expensive scrubbing pads quite often in order to feel secure in the knowledge that they are using an uncontaminated cleaning pad.

Examples of abrasive cleaning articles have been described in the past. See, for example, International Published Application Number WO 02/41748, U.S. Pat. Nos. 5,213,588, and 6,013,349.

The present invention addresses these and other problems encountered with scrubbing pads in the past and is directed to disposable scrubbing pads which can provide a wide variety in level of abrasiveness, may be thin, comfortable and easy to hold, may have good absorbency, and may provide benefits not previously supplied in abrasive cleaning articles of the past.

### SUMMARY OF THE INVENTION

The present invention discloses a cleaning implement for use in household cleaning applications. In one embodiment, the present invention is directed to a cleaning tool comprising a base, a handle extending from the base and a cleaning pad. The cleaning pad contains two separate cleaning surfaces that optionally can act on two separate planes simultaneously. In general, the two separate cleaning surfaces of the cleaning pad can comprise any known material useful in household cleaning applications. In one embodiment, the cleaning pad comprises one or more scrubbing layers and one or more adsorbent layers. In another embodiment, the scrubbing pad is a multi-layer laminate and generally includes one or more abrasive layers and one or more adsorbent layers.

### BRIEF DESCRIPTION OF THE DRAWINGS

FIG. 1—is a perspective view of one embodiment of the scrubbing product of the present invention;

FIG. 2—is an exploded perspective view of the scrubbing product shown in FIG. 1, showing a removable scrubbing pad containing two cleaning surfaces; and

FIG. 3—is a partial perspective view of the scrubbing product shown in FIG. 1, showing a means of attaching the scrubbing pad to the handle of the scrubbing product of the present invention.

### DETAILED DESCRIPTION OF THE INVENTION

The present invention is directed to a cleaning implement for use in household cleaning applications. In accordance with the present invention, the cleaning implement comprises a base, a handle extending from the base and a cleaning pad, which is attached to the base. The cleaning pad of the present invention contains two separate cleaning surfaces that optionally can act on two separate planes, simultaneously. In one embodiment, the cleaning pad is removable and disposable. In another embodiment, the cleaning pad is permanently attached to the base.

The handle of the cleaning implement will be any material that will facilitate gripping of the cleaning implement. The handle of the cleaning implement will preferably comprise any elongated, durable material that will provide practical cleaning. The length of the handle will be dictated by the end-use of the implement. Preferably, the handle is from 3.5 inches to 10 inches long, more preferably from 4 to 8 inches long. The handle will preferably extend from a base or a support head to which the cleaning pad can, optionally, be releasably attached. The base and handle typically comprise a single component (i.e., a single molded piece) and can be made of any known material. For examples, the base and handle can be made of plastic, wood, metal, rubber, or combinations thereof. The handle and base can be made of the same or different materials. The base and or handle can contain one or more dimples, indentations, grooves, ridges, etc. to allow for better gripping of the devise by the end user. For example, the base may optionally contain an indentation for the thumb and finger(s) allowing the end user to have more control of the device and/or allow the end user to apply extra pressure while cleaning.

Any suitable means for attaching the cleaning pad to the support head may be utilized, so long as the cleaning pad remains affixed during the cleaning process. Examples of suitable fastening means include, for example, clamps, hooks & loops, and the like. In one embodiment, the fastening means will comprise a flexible tab which snaps into a depression contained within the handle, thereby removably attaching said cleaning pad to the support head of the handle. In another embodiment, the cleaning pad is permanently attached or bonded to the base.

The two separate surfaces of the cleaning pad of the present invention comprise two separate cleaning surfaces (i.e., two separate pad surfaces), which optionally can act simultaneous to clean two separate planes. Typically, the two cleaning surfaces of the cleaning pad can be shaped so as to form a single convenient cleaning device which optionally can be used to clean two separate surfaces simultaneously, as desired by the user. For example, the cleaning implement of the present invention is convenient for cleaning or scrubbing floors, walls, windows, toilets, ceiling fans, and the like as well as for cleaning surfaces by polishing or sanding a surface. The angle between the two separate surfaces of the cleaning pad can vary from about 25 to about 120 degrees, preferably from about 60 to about 90 degrees.

The cleaning pad of the present invention can be any known cleaning pad in the art. For example, the cleaning pad can be a scrubbing product or scrubbing sponge. In one embodiment, the cleaning surface can be made of woven and/or non-woven fibers. In another embodiment, the cleaning pad of the present invention comprises a multi-layered pad, generally comprising at least two distinct layers. The cleaning pad of the present invention can be optionally removable or can be permanently attached or bonded to the base of the cleaning implement. In one embodiment, the cleaning pad can contain one or more cleaning solutions. In another embodiment, the cleaning pad can be recharged or refilled with one or more cleaning solutions, as needed, to allow for continued use.

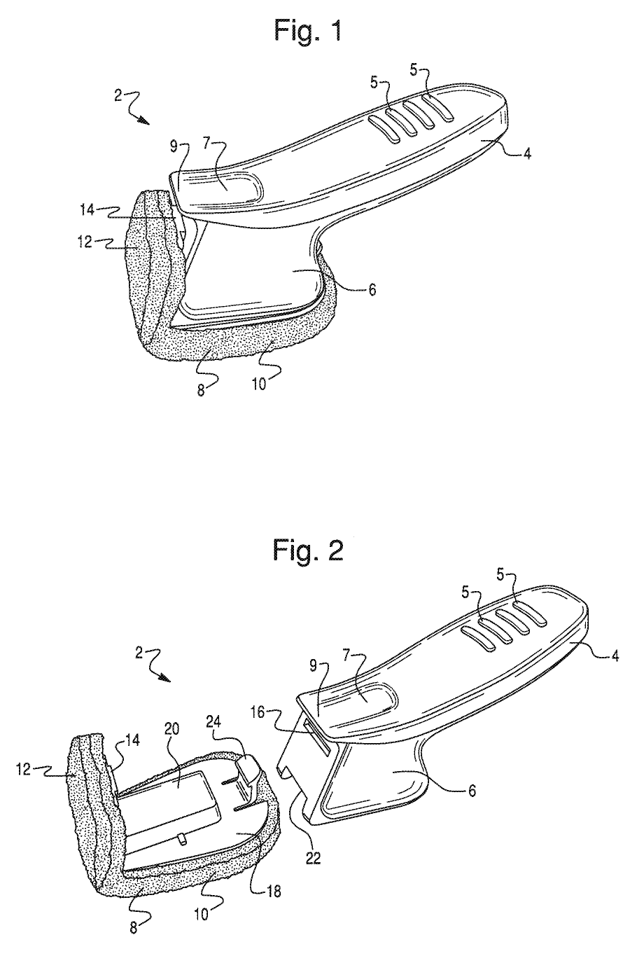

For exemplary purposes, one embodiment of the present invention is shown in FIGS. 1-3. Referring to FIGS. 1 and 2, a cleaning implement 2, in accordance to one embodiment of the present invention is shown. The cleaning implement 2 comprises a handle 4, for holding the cleaning implement 2 and a base 6 for attaching thereto a removable and disposable cleaning pad 8. As shown, the handle 4 can contain ridges 5 and one or more indentations to allow for better gripping of the devise by the end user. For example, the base may contain an indentation (not shown) and/or the handle 4 may contain an indentation 7. In one embodiment, the handle may also contain an integral scrapper 9, which can be used to scrap away difficult to remove soiling or staining from the surface to be cleaned. The cleaning pad 8 of the present invention has two cleaning surfaces 10, 12, respectfully, that optionally can act on two separate planes, simultaneously. The removable and disposable cleaning pad 8 can be attached to the base 6 by any known means in the art. For example, the cleaning pad 8 can be attached to the base 6 using a flexible tab 24 that snaps into an adjacent depression (not shown) contained within the base 6 and a tab 14 that aligns with an adjacent slot 16 in the base 6. To stabilize the cleaning pad 8, the cleaning pad 8 optionally contains a raised central portion 20 which fits into a groove 22 in the base 6.

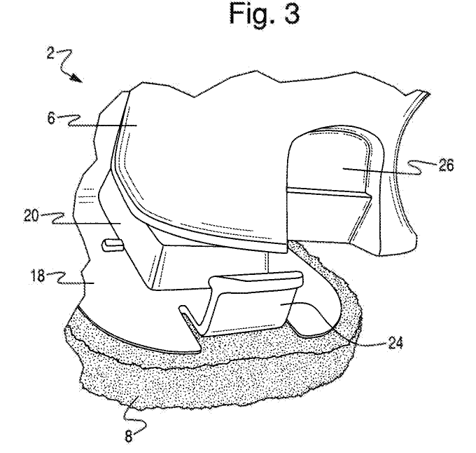

FIG. 3 shows a means for attaching the removable and disposable cleaning pad 8 from the base 6. The removable and disposable cleaning pad 8 can be attached to the base 6 by any known means in the art. For example, the cleaning pad 8 can be attached to base 6 using a flexible tab 24 that snaps into an adjacent depression 26 contained within the base 6 and a tab (not shown) that aligns with an adjacent slot (not shown) in the base 6. The flexible tab 24 snaps into the adjacent depression 24, holding the cleaning pad 8 into place. To remove the cleaning pad 8 from the base 6, the flexible tab 24 is pulled away from the base portion 6, thereby releasing the cleaning pad 8. To stabilize the cleaning pad 8, the cleaning pad 8 optionally contains a raised central portion 20 which fits into a groove (not show) in the base 6.

In one embodiment, the cleaning pad of the present invention may comprise a scrubbing or abrasive layer and an absorbent layer. In another embodiment, the cleaning pad comprises one or more abrasive layers and one or more absorbent layers. Typically, a first abrasive layer is secured over top of a second adsorbent layer. As such, the abrasive layer of the cleaning implement would come in direct contact with the soiled surface during cleaned. As such, materials useful as the abrasive layer must be sufficiently durable that the layer will retain its integrity during the cleaning process without damaging the surface being cleaned. In one embodiment, the two separate cleaning surfaces of the present invention can comprise two different abrasive materials. For example, one cleaning surface can contain a higher density or more abrasive material which can be used to scrub heavily soiled or stained surfaces. In addition, when the cleaning pad is used in combination with a solution, the abrasive layer must be capable of absorbing liquids and soils, and relinquishing those liquids and soils to the absorbent layer. This will ensure that the abrasive layer will continually be able to remove additional material from the surface being cleaned. Whether the implement is used with a cleaning solution (i.e., in the wet state) or without cleaning solution (i.e., in the dry state), the abrasive layer will, in addition to removing particulate matter, facilitate other functions, such as polishing, dusting, and buffing the surface being cleaned.

The abrasive layer can be a monolayer, or a multi-layer structure one or more of whose layers may be slitted to facilitate the scrubbing of the soiled surface and the uptake of particulate matter. This abrasive layer, as it passes over the soiled surface, interacts with the soil (and cleaning solution when used), loosening and emulsifying tough soils and permitting them to pass freely into the absorbent layer of the pad. Optionally, the abrasive layer may contain slits that provide an easy avenue for larger particulate soil to move freely in and become entrapped within the absorbent layer of the pad. Low density structures are preferred for use as the abrasive layer, to facilitate transport of particulate matter to the pad's absorbent layer.

In general, the scrubbing or abrasive layer of the cleaning pad of the present invention may include a material which is formed into an open, porous structure and has enough strength and hardness to form a rough, scratchy surface on the pad. Suitable materials are abundant and may be either natural or synthetic materials. Possible exemplary materials may include any known abrasive materials formed into the desired open structure. Possible synthetic materials may be polymeric materials, such as, for instance, meltspun nonwoven webs formed of molten or uncured polymers which may then harden to form the desired abrasive layer. In order to provide desired integrity, materials particularly suitable for the abrasive layer include synthetics such as polyolefins (e.g., polyethylene and polypropylene), polyesters, polyamides, synthetic cellulosics (e.g., Rayon®), and blends thereof. Such synthetic materials may be manufactured using known process such as carding, spunbonding, meltblowing, airlaying, needlepunching and the like.

In one embodiment, the abrasive layer of the cleaning pad may include a nonwoven meltblown web, such as may be formed using a thermoplastic polymer material. Generally, any suitable thermoplastic polymer that may be used to form meltblown nonwoven webs may be used for the abrasive layer of the scrubbing pads. A non-exhaustive list of possible thermoplastic polymers suitable for use include polymers or copolymers of polyolefins, polyesters, polypropylene, high density polypropylene, polyvinyl chloride, vinylidene chloride, nylons, polytetrafluoroethylene, polycarbonate, poly(methyl)acrylates, polyoxymethylene, polystyrenes, ABS, polyetheresters, or polyamides, polycaprolactan, thermoplastic starch, polyvinyl alcohol, polylactic acid, such as for example polyesteramide (optionally with glycerin as a plasticizer), polyphenylsulfide (PPS), poly ether ether ketone (PEEK), polyvinylidenes, polyurethane, and polyurea. For instance, in one embodiment, the abrasive layer may include meltblown nonwoven webs formed with a polyethylene or a polypropylene thermoplastic polymer. Polymer alloys may also be used in the abrasive layer, such as alloy fibers of polypropylene and other polymers such as PET. Compatibilizers may be needed for some polymer combinations to provide an effective blend. In one embodiment, the abrasive polymer is substantially free of halogenated compounds. In another embodiment, the abrasive polymer is not a polyolefin, but comprises a material that is more abrasive than say, polypropylene or polyethylene (e.g. having flexural modulus of about 1200 MPa and greater, or a Shore D hardness of 85 or greater).

The abrasive layer may comprise fibers of any suitable cross-section. For example, the fibers of the abrasive layer may include coarse fibers with circular or non-circular cross-sections. Moreover, non-circular cross-sectional fibers may include grooved fibers or multi-lobal fibers such as, for example, “4DG” fibers (specialty PET deep grooved fibers, with an eight-legged cross-section shape). Additionally, the fibers may be single component fibers, formed of a single polymer or copolymer, or may be multi-component fibers.

In an effort to produce an abrasive layer having desirable combinations of physical properties, in one embodiment, nonwoven polymeric fabrics made from multi-component or bicomponent filaments and fibers may be used. Bicomponent or multi-component polymeric fibers or filaments include two or more polymeric components which remain distinct. The various components of multi-component filaments are arranged in substantially distinct zones across the cross-section of the filaments and extend continuously along the length of the filaments. For example, bicomponent filaments may have a side-by-side or core and sheath arrangement. Typically, one component exhibits different properties than the other so that the filaments exhibit properties of the two components. For example, one component may be polypropylene which is relatively strong and the other component may be polyethylene which is relatively soft. The end result is a strong yet soft nonwoven fabric.

Optionally, the abrasive layer of the present invention may be formed from two or more different fiber types. For instance, the abrasive layer may be formed of different fiber types formed of different polymers or different combinations of polymers. Additionally, the abrasive layer may be formed of different fiber types including fibers of different orientations, i.e. curled or straight fibers, or fibers having different lengths or cross sectional diameters from each other. In one embodiment, the two separate cleaning surfaces of the cleaning implement of the present invention may comprise different abrasive materials. For example, one cleaning surface can contain a higher density or more abrasive material which can be used to scrub heavily soiled or stained surfaces.

The material used to form the abrasive layer may also contain various additives as desired. For example, various stabilizers may be added to a polymer, such as light stabilizers, heat stabilizers, processing aides, and additives that increase the thermal aging stability of the polymer. Further, auxiliary wetting agents, such as hexanol, antistatic agents such as a potassium alkyl phosphate, and alcohol repellants such as various fluoropolymers may also be present. Desired additives may be included in the abrasive layer either through inclusion of the additive to a polymer in the die or alternatively through addition to the abrasive layer after formation, such as through a spraying process.

In accordance with the present invention, the abrasive layer may be secured to one or more absorbent layers, such as that formed by a nonwoven paper web, to form a disposable cleaning pad. The absorbent layer serves to retain any fluid and soil absorbed by the cleaning pad during use. While the abrasive layer has some effect on the pad's ability to provide the requisite fluid absorption rates, the absorbent layer plays the major role in achieving the absorption rates and overall absorbency of the cleaning implement of the present invention.

The absorbent layer will be capable of removing fluid and soil from the abrasive layer so that the abrasive layer will have capacity to continually remove soil from the surface. The absorbent layer also should be capable of retaining absorbed material under typical in-use pressures to avoid “squeeze-out” of absorbed soil, cleaning solution, etc.

The absorbent layer will comprise any material that is capable of absorbing fluids at the requisite rates, and retaining such fluids during use. To achieve desired total fluid capacities, it will be preferred to include in the absorbent layer a material having a relatively high capacity.

In one embodiment, the absorbent layer comprises a paper web which is generally a web that contains high levels of bulk. Further, the web may have a substantial amount of wet strength and wet resilience for use in wet environments. The paper web, if desired, may also be highly textured and have a three-dimensional structure. For instance, the paper web may have an Overall Surface Depth (OSD) of greater than about 0.2 mm, and particularly greater than about 0.4 mm. In one embodiment, the paper web may be a commercial paper towel, such as a SCOTT® Towel or a VIVA® Towel, for instance. SCOTT® Towel, for example, has a wet:dry tensile strength ratio (ratio of the wet tensile strength to the dry tensile strength, taken in the cross direction) typically greater than 30% (e.g., one set of measurements gave a value of 38%), and VIVA® Towel has a wet:dry tensile strength ratio typically greater than 60% (e.g., one set of measurements gave a value of 71%). Wet:dry tensile strength ratios may also be greater than 10%, 20%, 40%, or 50%.

In one embodiment, the paper web may be a textured web which has been dried in a three-dimensional state such that the hydrogen bonds joining fibers were substantially formed while the web was not in a flat, planar state. For instance, the web may be formed while the web is on a highly textured through drying fabric or other three-dimensional substrate.

In order to improve wet resiliency, the paper web may contain wet resilient fibers, such as high-yield fibers. High-yield fibers include, for instance, thermomechanical pulp, such as bleached chemithermomechanical pulp (BCT&P). The amount of high-yield pulp fibers present in the sheet may vary depending upon the particular application. For instance, the high-yield pulp fibers may be present in an amount of about 5 dry weight percent or greater, or specifically, about 15 dry weight percent or greater, and still more specifically from about 15 to about 30%. In other embodiments, the percentage of high-yield fibers in the web may be greater than any of the following: about 30%, about 50%, about 60%, about 70%, and about 90%.

In general, the paper web may have a basis weight of greater than about 25 gsm (grams per square meter). Specifically, the paper web may have a basis weight greater than about 40 gsm, more specifically greater than about 50 gsm. If desired, the web may include a wet strength agent and/or at least about five percent (5%) by weight of high-yield pulp fibers, such as thermomechanical pulp. In addition to high-yield pulp fibers, the web may contain papermaking fibers, such as softwood fibers and/or hardwood fibers. In one embodiment, the web is made entirely from high-yield pulp fibers and softwood fibers. The softwood fibers may be present in an amount from about 95% to about 70% by weight.

In another embodiment, the absorbent layer may comprise a “superabsorbent material.” As used herein, the term “superabsorbent material” means any absorbent material having a g/g (grams of fluid per gram of absorbent material) capacity for water of at least about 15 g/g, when measured under a confining pressure of 0.3 psi. Because a majority of the cleaning fluids useful with the present invention are aqueous based, it is preferred that the superabsorbent materials have a relatively high g/g capacity for water and water-based fluids.

Representative superabsorbent materials include water insoluble, water-swellable superabsorbent gelling polymers (referred to herein as “superabsorbent gelling polymers”) which are well known in the literature. These materials demonstrate very high absorbent capacities for water. The superabsorbent gelling polymers useful in the present invention can have a size, shape and/or morphology varying over a wide range. These polymers can be in the form of particles that do not have a large ratio of greatest dimension to smallest dimension (e.g., granules, flakes, pulverulents, interparticle aggregates, interparticle crosslinked aggregates, and the like) or they can be in the form of fibers, sheets, films, foams, laminates, and the like. The use of superabsorbent gelling polymers in fibrous form provides the benefit of providing enhanced retention of the superabsorbent material, relative to particles, during the cleaning process. While their capacity is generally lower for aqueous-based mixtures, these materials still demonstrate significant absorbent capacity for such mixtures. The patent literature is replete with disclosures of water-swellable materials. See, for example, U.S. Pat. No. 3,699,103 (Harper et al.), issued Jun. 13, 1972; U.S. Pat. No. 3,770,731 (Harmon), issued Jun. 20, 1972; U.S. Reissue Pat. No. 32,649 (Brandt et al.), reissued Apr. 19, 1989; U.S. Pat. No. 4,834,735 (Alemany et al.), issued May 30, 1989.

Superabsorbent gelling polymers useful in the present invention include a variety of water-insoluble, but water-swellable polymers capable of absorbing large quantities of fluids. Such polymeric materials are also commonly referred to as “hydrocolloids”, and can include polysaccharides such as carboxymethyl starch, carboxymethyl cellulose, and hydroxypropyl cellulose; nonionic types such as polyvinyl alcohol, and polyvinyl ethers; cationic types such as polyvinyl pyridine, polyvinyl morpholinione, and N,N-dimethylaminoethyl or N,N-diethylaminopropyl acrylates and methacrylates, and the respective quaternary salts thereof. Typically, superabsorbent gelling polymers useful in the present invention have a multiplicity of anionic functional groups, such as sulfonic acid, and more typically carboxy, groups. Examples of polymers suitable for use herein include those which are prepared from polymerizable, unsaturated, acid-containing monomers. Thus, such monomers include the olefinically unsaturated acids and anhydrides that contain at least one carbon to carbon olefinic double bond. More specifically, these monomers can be selected from olefinically unsaturated carboxylic acids and acid anhydrides, olefinically unsaturated sulfonic acids, and mixtures thereof.

When the cleaning pad is comprised of multi-layers, the various layers may be bonded together utilizing any means that provides the pad with sufficient integrity during the cleaning process. The scrubbing and attachment layers, when present, may be bonded to the absorbent layer or to each other by any of a variety of bonding means, including the use of a uniform continuous layer of adhesive, a patterned layer of adhesive or any array of separate lines, spirals or spots of adhesive. Alternatively, the bonding means may comprise heat bonds, pressure bonds, ultrasonic bonds, dynamic mechanical bonds or any other suitable bonding means or combinations of these bonding means as are known in the art. Bonding may be around the perimeter of the cleaning pad (e.g., heat sealing the scrubbing layer and optional attachment layer), and/or across the area (i.e., the X-Y plane) of the cleaning pad so as to form a pattern on the surface of the cleaning pad. Bonding the layers of the cleaning pad with ultrasonic bonds across the area of the pad will provide integrity to avoid shearing of the discrete pad layers during use.

If desired, the cleaning pad may optionally include various additives, such as cleaning agents or medications, which may enhance the performance of the pads. Moreover, the scrubbing pads may exhibit translucence when wet, such that the user may see the surface being cleaned while scrubbing continues. Of particular advantage, it has been discovered that a synergy may occur between the component layers of the composite structure of the present invention, and the scrubbing pads may exhibit mechanical properties greater than the sum of the mechanical properties of the individual layers. For example, the tensile strength and the durability, among other mechanical properties, may be greater in the composite structure than the sum of the same properties in the individual layers. Similarly, the abrasiveness of the pad at the abrasive surface may be enhanced due to the texture of the attached absorbent layer.

The cleaning implement of the present invention is preferably used in combination with soaps and/or detergents. These soaps and/or detergents may consist of any known hard surface cleaning composition. Hard surface cleaning compositions are typically based on one or more surfactants, solvents, builders, chelants, polymers, suds booster or suppressors, enzymes, etc. Suitable surfactants include anionic, nonionic, zwitterionic, amphoteric and cationic surfactants. Examples of anionic surfactants include, but are not limited to, linear alkyl benzene sulfonates, alkyl sulfates, alkyl ether sulfates, alkyl sulfonates, alkali metal salts of fatty acids, and the like. Examples of nonionic surfactants include alkylethoxylates, alkylphenolethoxylates, alkylpolyglucosides, alkylglucamines, sorbitan esters, and the like. Examples of zwitterionic surfactants include betaines and sulfobetaines. Examples of amphoteric surfactants include materials derived using imidazole chemistry, such as alkylampho glycinates, and alkyl imino propionate. Examples of cationic surfactants include alkyl mono-, di-, and tri-ammonium surfactants. All of the above materials are available commercially, and are described in McCutcheon's Vol. 1: Emulsifiers and Detergents, North American Ed., McCutheon Division, MC Publishing Co., 1995.

Suitable solvents include short chain (e.g., C₁-C₆) derivatives of oxyethylene glycol and oxypropylene glycol, such as mono- and di-ethylene glycol n-hexyl ether, mono-, di- and tri-propylene glycol n-butyl ether, and the like. Suitable builders include those derived from phosphorous sources, such orthophosphate and pyrophosphate, and non-phosphorous sources, such as nitrilotriacetic acid, S,S-ethylene diamine disuccinic acid, and the like. Suitable chelants include ethylene diamine tetra acetic acid and citric acid, and the like. Suitable polymers include those that are anionic, cationic, zwitterionic, and nonionic. Suitable suds boosters include alkanolamides, amine oxides, betaines and the like. Suitable suds suppressors include silicone polymers and linear or branched C₁₀-C₁₈ fatty acids or alcohols. Suitable enzymes include lipases, proteases, amylases and other enzymes known to be useful for catalysis of soil degradation.

A suitable cleaning product for use with the present implement comprises from about 30.0% to about 70.0% of a linear alcohol ethoxylate surfactant (e.g., Rhodasurf TB 970 FLK®, available from Rhodia Chemical Co.); from about 30.0% to about 70.0% of an alkylethersulfate (e.g., Steol CS 370®, available from Stepan Co.); from about 0 to about 0.1% potassium hydroxide; from about 0 to about 0.1% potassium carbonate or bicarbonate; from about 0 to about 10% organic acids, optional adjuvants such as dyes and/or perfumes.

What is claimed is:

1. A cleaning implement comprising:
(a) a base;
(b) a handle extending from said base;
(c) an optionally removable cleaning pad wherein said cleaning pad contains two separate cleaning surfaces; and
(d) a means of attaching said cleaning pad to said base.

2. The cleaning implement of claim 1, wherein said handle is from 3.5 inches to 10 inches long.

3. The cleaning implement of claim 1, wherein said handle contains ridges.

4. The cleaning implement of claim 1, wherein said handle contains an integral scraper.

5. The cleaning implement of claim 1, wherein said base contains one or more indentations.

6. The cleaning implement of claim 1, wherein said cleaning pad comprises at least one abrasive layer and at least one absorbent layer.

7. The cleaning implement of claim 6, wherein said cleaning pad contains a first abrasive layer and a second absorbent layer, and wherein said first abrasive layer is secured over said second absorbent layer.

8. The cleaning implement of claim 1, wherein said means of attaching said cleaning pad to said base comprise a flexible tab which snaps into a depression contained within said handle.

9. The cleaning implement of claim 1, wherein said two separate cleaning surfaces are on two separate planes.

10. The cleaning implement of claim 1, wherein said planes are intersecting planes.

11. The cleaning implement of claim 9, wherein there is an angle between said two separate planes and wherein said angle is from about 25 to about 120 degrees.

12. The cleaning implement of claim 11, wherein said angle is between about 60 and about 90 degrees.

13. The cleaning implement of claim 6, wherein said abrasive layer is made of a natural or synthetic material.

14. The cleaning implement of claim 13, wherein said abrasive layer is made of a polymeric material.

15. The cleaning implement of claim 14, wherein said polymeric material is selected from the group consisting of polyolefins, polyethylene, polypropylene, polyesters, polyamides, synthetic cellulosics, blends thereof, and meltspun nonwoven webs formed of molten or uncured polymers.

16. The cleaning implement of claim 13, wherein said synthetic materials are made by using process such as carding, spunbonding, meltblowing, airlaying, needlepunching, or combinations thereof.

17. The cleaning implement of claim 6, wherein said abrasive layer further contains one or more additives.

18. The cleaning implement of claim 6, wherein said absorbent layer comprises a paper web.

19. The cleaning implement of claim 18, wherein said paper web contains a wet:dry tensile strength ratios greater than 10%.

20. The cleaning implement of claim 6, wherein said absorbent layer comprises water insoluble or water-swellable gelling polymer.

21. The cleaning implement of claim 20, wherein said water insoluble or water-swellable gelling polymer is selected from the group consisting of polysaccharides, carboxymethyl starch, carboxymethyl cellulose, hydroxypropyl cellulose, polyvinyl alcohol, polyvinyl ethers, polyvinyl pyridine, polyvinyl morpholinione, and N,N-dimethylaminoethyl or N,N-diethylaminopropyl acrylates and methacrylates.

22. The cleaning implement of claim 1, wherein said cleaning pad contains one or more cleaning products.

23. The cleaning implement of claim 22, wherein said cleaning pad contains a cleaning product and wherein said cleaning product comprises from about 20% to about 60% of a polyethoxylated alcohol, from about 20% to about 60% sodium laureth sulfate and from about 0.05% to about 2% of a fragrance or perfume.

24. The cleaning implement of claim 22, wherein said cleaning pad contains a cleaning product and wherein said cleaning product comprises from about 40% to about 45% of a polyethoxylated alcohol, from about 50% to about 55% sodium laureth sulfate and from about 0.1% to about 0.5% of a fragrance or perfume.
